(19) United States
(12) Patent Application Publication
(10) Pub. No.: US 2019/0121908 A1
(43) Pub. Date: Apr. 25, 2019

(54) INFORMATION PROCESSING SYSTEM AND METHOD

(71) Applicant: SAVITECH CORP., Zhubei City (TW)

(72) Inventor: Shan-Yu LIN, Zhubei City (TW)

(73) Assignee: SAVITECH CORP., Zhubei City (TW)

(21) Appl. No.: 15/869,967

(22) Filed: Jan. 12, 2018

(30) Foreign Application Priority Data
Oct. 24, 2017 (TW) 106136478

(51) Int. Cl. G06F 17/30; G06F 3/16; H04W 76/14; H04W 4/80

(52) U.S. Cl. CPC G06F 17/30775; G06F 3/165; G06F 17/30778; H04W 4/80; G06F 17/30174; H04W 76/14

(57) ABSTRACT

An information processing system and method is disclosed, applicable to music content browsing environment of BLE connected audio playback device. The information processing method includes: a handheld device and a BLE connected audio playback device performing BLE connection; the handheld device and the BLE connected audio playback device performing music content database synchronization; the handheld device performing browsing/control of the playback app; performing playback control of selected music content; and finally the BLE connected audio playback device performing playback of the selected music; wherein, the remote audio playback protocol using BLE channel performing access/browsing/control of built-in audio files on the BLE connected audio playback device so as to perform decode/playback, or transmitting audio files to BLE connected audio playback device for direct decoding and playback.

### CROSS-REFERENCE TO RELATED APPLICATION

The present application is based on, and claims priority form, Taiwan Patent Application No. 106136478, filed Oct. 24, 2017, the disclosure of which is hereby incorporated by reference herein in its entirety.

### TECHNICAL FIELD

The technical field generally relates to an information system and method, and in particular, to an information processing system and method applicable to music content browsing environment of BLE connected audio playback device; before a BLE connected audio playback device playing the music, the browsing/control of the playback app being performed; through the remote audio playback protocol using BLE channel performing access/browsing/control of built-in audio files on the BLE connected audio playback device so as to perform decode/playback, or transmitting audio files to BLE connected audio playback device for direct decoding and playback.

### BACKGROUND

For the current audio playback device to process music content, the playback device can only play music directly, and is unable to easily use the handheld device screen to browse and select the built-in audio files stored in the audio playback device to select the desired music to play. In other words, the user can neither easily browse and select all the music contents on the audio device, nor easily select the desired music to play from a music file list.

Taiwan Patent No. 1395442 disclosed “COMMUNICATION IN DUAL PROTOCOL ENVIRONMENTS”, wherein a communication device comprising: a first communication system for transmitting and/or receiving signals according to a first protocol; a second communication system for transmitting and receiving signals according to a second protocol, the second protocol having the facility that a receiver can indicate to a transmitter that it is in an unresponsive state whereby the transmitter can be inhibited from transmitting data to the receiver when it is in the unresponsive state; a signal activity detector for detecting activity in the signals of the first protocol; and a control unit responsive to the signal timing detector for causing the second communication system to indicate that it is in an unresponsive state.

Taiwan Patent No. 1572155 disclosed “MULTI-ROLE BLUETOOTH DEVICE AND CONNECTION METHOD THEREOF”, wherein a multi role Bluetooth device stores a plurality of SDPs (Service Discovery Protocols), and is able to connect to an electron device with a Bluetooth interface by one of stored SDPs. The multi role Bluetooth device can connect with the electron device by a first SDP, and transmit and/or receive an audio signal with the electron device each other via Bluetooth. Furthermore, the multi role Bluetooth device also can connect with the electron device by a second SDP, and transmit a command signal to the electron device via Bluetooth to control the electron device to execute some function thereof.

Taiwan Patent No. 1563806 disclosed “BLUETOOTH DEVICE AND METHOD FOR CONTROLLING BLUETOOTH DEVICE OR WIRELESS DEVICE”, wherein a method for controlling a Bluetooth device for power conservation includes the steps of: establishing a Bluetooth link; controlling the Bluetooth device to enter sniff mode; handling a sniff anchor point after wakeup preparation and before sleep preparation; and handling a wakeup operation between the wakeup preparation and the sleep preparation. The wakeup operation is a BT, BLE (Bluetooth Low Energy) operation or a Wi-Fi operation. The wakeup/sleep preparation can be also done as few times as possible in the invention such that the power consumption of the Bluetooth device is effectively reduced.

Taiwan Patent No. 1449381 disclosed “COMMUNICATION METHOD AND BLUETOOTH DEVICE”, wherein a communication method for a Bluetooth device in a scatternet which may include several piconets is proposed. The method includes transmitting data to a peer device in the first piconet, determining whether there is any buffered data to be transmitted to the peer device in the first piconet, and switching from the first piconet to a second piconet to transmit data to a peer device in the second piconet according to the determination result.

Therefore, it remains an imperative issue how to solve the aforementioned problems of current audio playback device wherein the playback device can only play music directly, and is unable to easily use the handheld device screen to browse and select the built-in audio files stored in the audio playback device to select the desired music to play. In other words, the user can neither easily browse and select all the music contents on the audio device, nor easily select the desired music to play from a music file list.

### SUMMARY

The present invention is related to an information system and method, and in particular, to an information processing system and method applicable to music content browsing environment of BLE connected audio playback device; before a BLE connected audio playback device playing the music, the browsing/control of the playback app being performed; through the remote audio playback protocol using BLE channel performing access/browsing/control of built-in audio files on the BLE connected audio playback device so as to perform decode/playback, or transmitting audio files to BLE connected audio playback device for direct decoding and playback.

Another object of the present invention is to provide an information processing system and method, applicable to music content browsing environment of BLE connected audio playback device, to enable the user to browse and select all the music contents on the audio device from a music file list, in addition to directly playing the built-in audio file in the audio device.

Yet another object of the present invention is to provide an information processing system and method, applicable to music content browsing environment of BLE connected audio playback device, to use remote audio playback protocol of BLE channel to obtain BLE connected audio device music contents, such as, BLE headset/speaker, stored music content, to enable user to browse and select the desired music to play; moreover, able to transmit music files directly from electronic device, such as, mobile phone, to BLE connected audio device, such as, BLE headset/speaker, for decoding and playback to avoid distortion caused by multi-decoding of the music files.

To achieve the aforementioned object, the present invention provides an information processing system, comprising: a transmission module, a processing module, and a database; wherein the information processing system is located in an electronic device, such as, Android mobile phone, tablet PC, iPhone, iPad, and the BLE connected audio device collaborating with the electronic device can be, such as, BLE headset/speaker; the transmission module and/or the processing module comprises at least one of the combination of hardware, firmware, and software.

The BLE connected audio device establishes a media file server, and enables BLE interface to collaborate with the transmission module of the information processing system so as to establish BLE communication channel.

The transmission module enables the BLE interface and collaborates with the BLE connected audio device so as to establish BLE communication channel.

A media content manager of the processing module and/or a media content manager of the electronic device uses the transmission module and the BLE communication channel to execute a browsing command process to the BLE connected audio device; the media content manager obtains metadata from the media file server from the BLE connected audio device, and/or stores the metadata to the database; a media player of the processing module and/or a media player of the electronic device navigates the metadata of the media content manager; the processing module provides a user interface to a screen of the electronic device so that the user can easily browse all the music contents on the audio device from a music file list and select a desired music to play; and, the media player accesses and monitors media playback state of the BLE connected audio device, wherein the media player controls the media playback of the BLE connected audio device, including: playing, paused, stopped, seek forward, seek backward, volume up, and volume down.

The database stores the metadata from the media file server of the BLE connected audio device.

When an electronic device using the information processing system of the present invention to process information, the system first executes connection: performing BLE connection to a BLE connected audio device; the transmission module of the information processing system in the electronic device enabling BLE interface and pairing with BLE connected audio device to establish BLE communication channel.

Then, the system performs synchronization: performing database synchronization with the BLE connected audio device; the media content manager of the information processing system in the electronic device and/or the media content manager in the electronic device uses the transmission module and the BLE communication channel to execute browsing command process to the BLE connected audio device; the media content manager obtains metadata from the media file server from the BLE connected audio device, and/or stores the metadata to the database.

Then, the system performs app browsing/control: the media player of the processing module and/or the media player of the electronic device navigates the metadata of the media content manager; the processing module provides a user interface to a screen of the electronic device so that the user can easily browse all the music contents on the audio device from a music file list and select a desired music to play.

Then, the system performs music content playback control: the media player accesses and monitors media playback state of the BLE connected audio device, wherein the media player controls the media playback of the BLE connected audio device, including: playing, paused, stopped, seek forward, seek backward, volume up, and volume down.

Finally, the BLE connected audio device performs music playback.

Wherein, the remote audio playback protocol uses BLE channel performing access/browsing/control of built-in audio files on the BLE connected audio device so as to perform decode/playback, or transmits audio files to BLE connected audio device for direct decoding and playback.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of the architecture and operation of the information processing system of the present invention;

FIG. 2 shows a flowchart of the steps of using the information processing system in FIG. 1 to process information;

FIG. 3 shows a schematic view of the architecture and operation of an embodiment of the information processing system of the present invention; and

FIG. 4 shows a flowchart of the steps of using the embodiment of the information processing system in FIG. 3 to process information.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

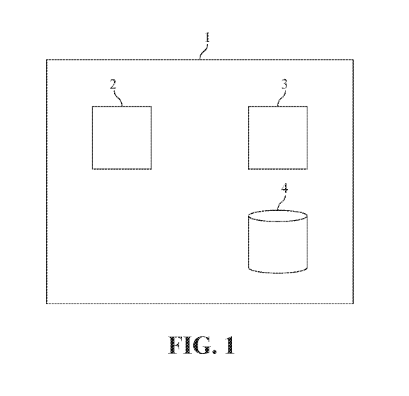

FIG. 1 shows a schematic view of the architecture and operation of the information processing system of the present invention. As shown in FIG. 1, the information processing system 1 comprises at least: a transmission module 2, a processing module 3, and a database 4; wherein the information processing system 1 is located in an electronic device (not shown), such as, Android mobile phone, tablet PC, iPhone, iPad, and the BLE connected audio device (not shown) collaborating with the electronic device can be, such as, BLE headset/speaker; the transmission module 2 and/or the processing module 3 comprises at least one of the combination of hardware, firmware, and software.

The BLE connected audio device establishes a media file server, and enables BLE interface to collaborate with the transmission module of the information processing system so as to establish BLE communication channel.

The transmission module 2 enables the BLE interface and collaborates with the BLE connected audio device so as to establish BLE communication channel.

A media content manager (now shown) of the processing module 3 and/or a media content manager of the electronic device uses the transmission module 2 and the BLE communication channel to execute a browsing command process to the BLE connected audio device; the media content manager obtains metadata from the media file server from the BLE connected audio device, and/or stores the metadata to the database 4; a media player of the processing module 3 and/or a media player of the electronic device navigates the metadata of the media content manager; the processing module 3 provides a user interface (now shown) to a screen of the electronic device so that the user can easily browse all the music contents on the audio device from a music file list and select a desired music to play; and, the media player accesses and monitors media playback state of the BLE connected audio device, wherein the media player controls the media playback of the BLE connected audio device, including: playing, paused, stopped, seek forward, seek backward, volume up, and volume down.

The database 4 stores the metadata from the media file server of the BLE connected audio device.

Depending on actual application, the information processing system 1 can be installed in a smart phone, iPhone, tablet PC, iPad, or similar electronic devices; the transmission module 2 and/or the processing module 3 comprises at least one of the combination of hardware, firmware, and software, to collaborate with a processor (not shown) of the smart phone, iPhone, tablet PC, iPad, or similar electronic devices where the information processing system 1 is installed in.

Also, in actual application, when the electronic device is one of the smart phone, iPhone, tablet PC, iPad, the user interface will be a smart phone App interface, iPhone App interface, tablet PC App interface, iPad App interface, accordingly.

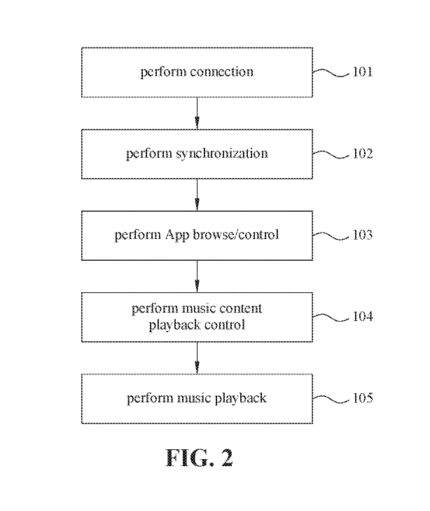

FIG. 2 shows a flowchart of the steps of using the information processing system in FIG. 1 to process information. As shown in FIG. 2, when an electronic device using the information processing system of the present invention to process information, the system first executes connection (step 101): performing BLE connection to a BLE connected audio device; the transmission module 2 of the information processing system 1 in the electronic device enabling BLE interface and pairing with BLE connected audio device to establish BLE communication channel; and then proceed to step 102.

In step 102, the information processing system 1 performs synchronization: performing database synchronization with the BLE connected audio device; the media content manager of the processing module 3 of the information processing system 1 in the electronic device and/or the media content manager in the electronic device uses the transmission module 2 and the BLE communication channel to execute browsing command process to the BLE connected audio device; the media content manager obtains metadata from the media file server from the BLE connected audio device, and/or stores the metadata to the database 4; and proceed to step 103. In other words, the processing module 3 performs database synchronization with the BLE connected audio device through the transmission module 2 and the BLE communication channel.

In step 103, the information processing system 1 performs app browsing/control: the media player of the processing module 3 and/or the media player of the electronic device navigates the metadata of the media content manager; the processing module 3 provides a user interface to a screen of the electronic device so that the user can easily browse all the music contents on the audio device from a music file list and select a desired music to play, and proceed to step 104.

In step 104, the information processing system 1 performs music content playback control: the media player accesses and monitors media playback state of the BLE connected audio device, wherein the media player controls the media playback of the BLE connected audio device, including: playing, paused, stopped, seek forward, seek backward, volume up, and volume down, and then proceed to step 105.

In step 105, the BLE connected audio device performs music playback.

Wherein, the remote audio playback protocol uses BLE channel performing access/browsing/control of built-in audio files on the BLE connected audio device so as to perform decode/playback, or transmits audio files to BLE connected audio device for direct decoding and playback.

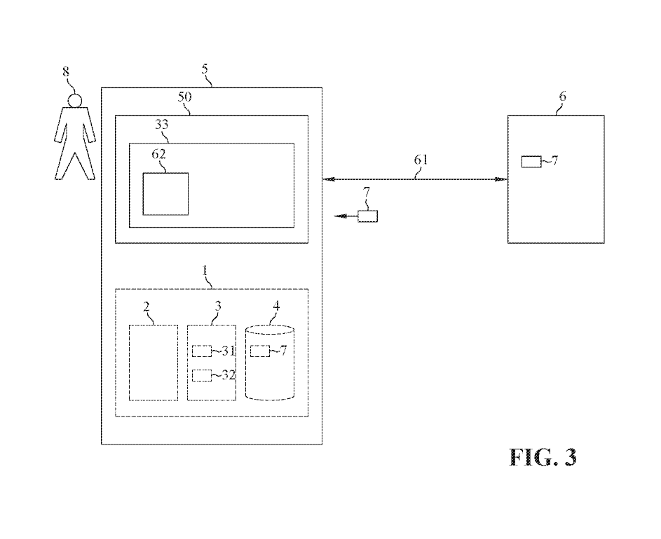

FIG. 3 shows a schematic view of the architecture and operation of an embodiment of the information processing system of the present invention. As shown in FIG. 3, the information processing system 1 comprises at least: a transmission module 2, a processing module 3, and a database 4; wherein the information processing system 1 is located in an Android mobile phone 5 (i.e., the electronic device 5), and the BLE connected audio device 6 collaborating with the electronic device 5 is, such as, BLE headset/speaker; the transmission module 2 and/or the processing module 3 comprises at least one of the combination of hardware, firmware, and software.

The BLE connected audio device 6 establishes a media file server (now shown), and enables BLE interface to collaborate with the transmission module 2 of the information processing system 1 so as to establish BLE communication channel 61.

The transmission module 2 enables the BLE interface and collaborates with the BLE connected audio device 6 so as to establish BLE communication channel 61.

A media content manager 31 of the processing module 3 and/or a media content manager of the electronic device uses the transmission module 2 and the BLE communication channel 61 to execute a browsing command process to the BLE connected audio device 6; the media content manager 31 obtains metadata 7 from the media file server from the BLE connected audio device 6, and/or stores the metadata 7 to the database 4; a media player 32 of the processing module 3 and/or a media player of the electronic device navigates the metadata 7 of the media content manager 31; the processing module 3 provides a user interface 33 to a screen 50 of the electronic device 5 so that the user 8 can easily browse all the music contents on the audio device 6 from a music file list 62 on the user interface 33 on the screen 50 and select a desired music to play; and, the media player 32 accesses and monitors media playback state of the BLE connected audio device 6, wherein the media player 32 controls the media playback of the BLE connected audio device 6, including: playing, paused, stopped, seek forward, seek backward, volume up, and volume down.

The database 4 stores the metadata 7 from the media file server of the BLE connected audio device 6.

Although in the present embodiment, the information processing system 1 is installed in an Android mobile phone, however, the information processing system 1 can also be installed in iPhone, tablet PC, iPad, or similar electronic devices; the transmission module 2 and/or the processing module 3 comprises at least one of the combination of hardware, firmware, and software, to collaborate with a processor (not shown) of the Android mobile phone, iPhone, tablet PC, iPad, or similar electronic devices where the information processing system 1 is installed in.

Also, in actual application, when the electronic device 5 is an Android mobile phone, the user interface 33 will be a Android mobile phone App interface, accordingly.

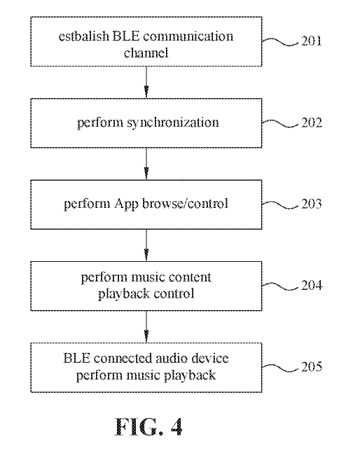

FIG. 4 shows a flowchart of the steps of using the embodiment of the information processing system in FIG. 3 to process information. As shown in FIG. 4, when an electronic device using the information processing system of the present invention to process information, the system first executes connection (step 201): performing BLE connection to a BLE connected audio device 6; the transmission module 2 of the information processing system 1 in the electronic device 5 enabling BLE interface and pairing with BLE connected audio device 6 to establish BLE communication channel 61; and then proceed to step 202.

In step 202, the information processing system 1 performs synchronization: performing database synchronization with the BLE connected audio device 6; the media content manager 31 of the processing module 3 of the information processing system 1 in the electronic device 5 and/or the media content manager in the electronic device uses the transmission module 2 and the BLE communication channel 61 to execute browsing command process to the BLE connected audio device 6; the media content manager 31 obtains metadata 7 from the media file server from the BLE connected audio device 6, and/or stores the metadata to the database 4; and proceed to step 203.

In step 203, the information processing system 1 performs app browsing/control: the media player 32 of the processing module 3 and/or the media player of the electronic device 5 navigates the metadata 7 of the media content manager 31; the processing module 3 provides a user interface 33 to a screen 50 of the electronic device 5 so that the user can easily browse all the music contents on the audio device from a music file list 62 on the user interface 33 on the screen 50 and select a desired music to play, and proceed to step 204.

In step 204, the information processing system 1 performs music content playback control: the media player 32 accesses and monitors media playback state of the BLE connected audio device 6, wherein the media player 32 controls the media playback of the BLE connected audio device 6, including: playing, paused, stopped, seek forward, seek backward, volume up, and volume down, and then proceed to step 105.

In step 205, the BLE connected audio device 6 performs music playback.

Wherein, the remote audio playback protocol uses BLE channel 61 performing access/browsing/control of built-in audio files on the BLE connected audio device 6 so as to perform decode/playback, or transmits audio files to BLE connected audio device 6 for direct decoding and playback.

In summary, the information processing system and method provided by the present invention is applicable to music content browsing environment of BLE connected audio playback device. The information processing method used by the information processing system includes: a handheld device and a BLE connected audio playback device performing BLE connection; the handheld device and the BLE connected audio playback device performing music content database synchronization; the handheld device performing browsing/control of the playback app; performing playback control of selected music content; and finally the BLE connected audio playback device performing playback of the selected music; wherein, the remote audio playback protocol using BLE channel performing access/browsing/control of built-in audio files on the BLE connected audio playback device so as to perform decode/playback, or transmitting audio files to BLE connected audio playback device for direct decoding and playback. The present invention provides the following advantages:

1. using the remote audio playback protocol through BLE channel to obtain access/browsing/control of built-in audio files on the BLE connected audio playback device so as to perform decode/playback, or transmitting audio files to BLE connected audio playback device for direct decoding and playback.

2. enabling the user to browse and select all the music contents on the audio device from a music file list, in addition to directly playing the built-in audio file in the audio device.

3. using remote audio playback protocol of BLE channel to obtain stored music content on the BLE connected audio device music contents, such as, BLE headset/speaker, to enable user to browse and select the desired music to play; moreover, able to transmit music files directly from electronic device, such as, mobile phone, to BLE connected audio device, such as, BLE headset/speaker, for decoding and playback to avoid distortion caused by multi-decoding of the music files.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An information processing method, applicable to an environment of browsing music content of Bluetooth Low Energy (BLE) connected audio device, comprising the steps of:
performing connection: performing BLE connection to a BLE connected audio device to establish a BLE communication channel;
performing synchronization: performing database synchronization with the BLE connected audio device;
performing playback application program (App) browsing/control: browsing all music contents of built-in audio files built-in stored in the BLE connected audio device through a music file list, and selecting a desired music for playback;
performing music content playback control; and
the BLE connected audio device performing music playback;
wherein a remote audio playback protocol using BLE channel to perform access/browsing/control of built-in audio files on the BLE connected audio device so as to perform decode/playback, or transmitting audio files to BLE connected audio device for direct decoding and playback.

2. The information processing method as claimed in claim 1, wherein in the step of performing connection, an electronic device and the BLE connected audio device perform the BLE connection to establish the BLE communication channel.

3. The information processing method as claimed in claim 1, wherein in the step of performing synchronization, an electronic device executes a browsing command process to the BLE connected audio device; and a media content manager obtains metadata from a media file server from the BLE connected audio device.

4. The information processing method as claimed in claim 2, wherein the electronic device is one of the following: Android phone, iPhone, tablet PC, and iPad.

5. The information processing method as claimed in claim 3, wherein the electronic device is one of the following: Android phone, iPhone, tablet PC, and iPad.

6. An information processing system, applicable to an environment of browsing music content of Bluetooth Low Energy (BLE) connected audio device, comprising at least:
a transmission module, the transmission module and the BLE connected audio device performing BLE connection to establish BLE communication channel;
a processing module, the processing module performing database synchronization with the BLE connected audio device through the transmission module and the BLER communication channel; the processing module providing a user interface to enable a user to use a music file list to browse all the music contents of built-in audio files stored in the BLE connected audio device, and to select a desired music for playback;
the processing module also performing music playback control;
a database, the processing module storing the metadata from the BLE connected audio device to the database.

7. The information processing system as claimed in claim 6, wherein a remote audio playback protocol uses BLE channel to perform access/browsing/control of built-in audio files on the BLE connected audio device so as to perform decode/playback, or transmitting audio files to BLE connected audio device for direct decoding and playback.

8. The information processing system as claimed in claim 6, wherein in performing database synchronization, the processing module executes a browse command process to the BLE audio device.

9. The information processing system as claimed in claim 6, wherein the information processing system is installed on an electronic device, and the electronic device is one of the following: Android phone, iPhone, Tablet PC, and iPad.

10. The information processing system as claimed in claim 8, wherein a media content manager of the processing module obtains metadata from a media file server of the BLE connected audio device.
